(19) United States
(12) Patent Application Publication
(10) Pub. No.: US 2009/0153293 A1
(43) Pub. Date: Jun. 18, 2009

(54) SYSTEM AND METHOD FOR CONTROLLING ACCESS TO A HANDHELD DEVICE BY VALIDATING FINGERPRINTS

(75) Inventor: MENG-CHIEH CHOU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/136,777

(22) Filed: Jun. 11, 2008

(30) Foreign Application Priority Data
Dec. 14, 2007 (CN) 200710203075.X

(51) Int. Cl. G06K 9/78

(52) U.S. Cl. 340/5.53

(57) ABSTRACT

A method for controlling access to a handheld device (1) by validating fingerprints includes: storing original fingerprint characteristic values of corresponding user accounts in a memory (12) of the handheld device; controlling a fingerprint scanning device (11) in the handheld device to scan a login fingerprint of a user accessing one of the user accounts, and obtaining a login fingerprint image correspondingly; processing the login fingerprint image, and obtaining a negative image of the login fingerprint image; detecting login fingerprint characteristic points in the negative image of the login fingerprint image, and computing login fingerprint characteristic values according to the login fingerprint characteristic points; determining whether the login fingerprint characteristic values match original fingerprint characteristic values of one of the user accounts in the memory; and granting access to the user account if the login fingerprint characteristic values match the original fingerprint characteristic values of the user account.

### BACKGROUND OF THE INVENTION

1. Field of the Invention

The present invention generally relates to systems and methods for controlling access to an electronic device, and particularly to a system and method for controlling access to a handheld device by validating fingerprints.

2. Description of Related Art

Generally, a handheld device is a pocket-sized computing device, which typically includes a small visual display for output and a miniature keyboard or touch screen for input. Handheld devices may be mobile phones, personal digital assistants (PDAs), handheld game players, digital cameras, etc.

Handheld devices are popular because they are as powerful as a conventional computer and can store and analyze various kinds of private information (i.e., personal data, phone lists, message records, trading information and call histories, etc). However, if the private information is compromised, the owner of the handheld device may suffer great losses. Therefore, it is necessary to ensure information security of the handheld device. A conventional method for ensuring the information security of the handheld device is to set passwords for the handheld device. However the conventional method still faces other security risks, such as, the passwords are easy to be deciphered.

Accordingly, what is needed is a system and method for controlling access to a handheld device by validating user fingerprints.

### SUMMARY

A method for controlling access to a handheld device by validating fingerprints is provided. The method includes: storing original fingerprint characteristic values of corresponding user accounts in a memory of the handheld device; controlling a fingerprint scanning device in the handheld device to scan a login fingerprint of a user accessing one of the user accounts, and obtaining a login fingerprint image correspondingly; processing the login fingerprint image, and obtaining a negative image of the login fingerprint image; detecting login fingerprint characteristic points in the negative image of the login fingerprint image, and computing login fingerprint characteristic values according to the login fingerprint characteristic points; determining whether the login fingerprint characteristic values match original fingerprint characteristic values of one of the user accounts in the memory; and granting access to the user account if the login fingerprint characteristic values match the original fingerprint characteristic values of the user account in the memory.

Other systems, methods, features, and advantages will be or become apparent to one skilled in the art upon examination of the following drawings and detailed description.

### BRIEF DESCRIPTION OF THE DRAWINGS

FIG. 1 is a block diagram of a system for controlling access to a handheld device by validating fingerprints in accordance with one exemplary embodiment.

FIG. 2 is a schematic diagram of an exemplary embodiment of the fingerprint scanning device in FIG. 1.

FIG. 3 is a schematic diagram of another exemplary embodiment of the fingerprint scanning device in FIG. 1.

FIG. 4 is a flowchart of a method for controlling access to a handheld device by validating fingerprints in accordance with the exemplary embodiment.

FIG. 5 is a graphical representation of characteristic points in accordance with the exemplary embodiment.

FIG. 6 is a graphical representation of establishing a coordinate system on the characteristic points in accordance with the exemplary embodiment.

FIG. 7 is a graphical representation of a linked shape of the characteristic points of a fingerprint in accordance with the exemplary embodiment.

### DETAILED DESCRIPTION OF THE EMBODIMENTS

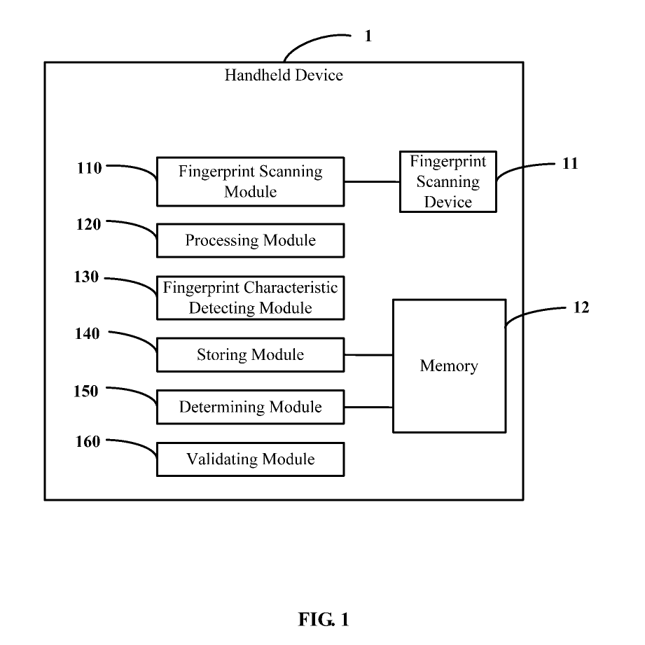

FIG. 1 is a block diagram of a system for controlling access to a handheld device by validating fingerprints in accordance with one exemplary embodiment. The system typically includes a handheld device 1. The handheld device 1 includes a fingerprint scanning device 11 and a memory 12.

The handheld device 1 may be a mobile phone, a personal digital assistant (PDA), a handheld game player, a digital camera, a palm computer, or other portable electronic devices.

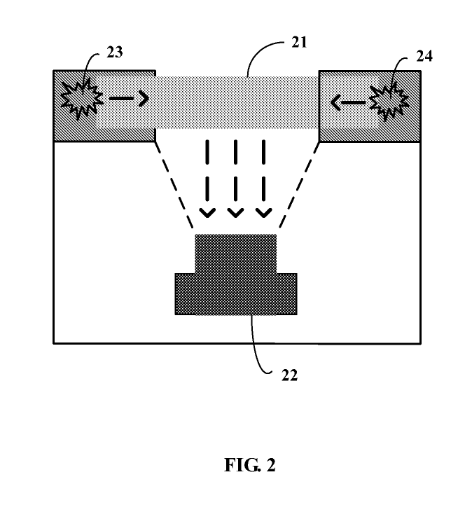

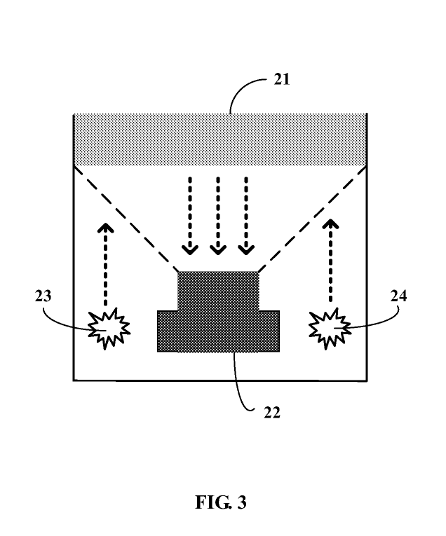

The fingerprint scanning device 11 is configured for scanning and obtaining fingerprint images. The fingerprint scanning device 11 may be a camera, or a fingerprint identification instrument. FIGS. 2 and 3 are two exemplary embodiments of the fingerprint scanning device 11, which includes a transparent panel 21, a camera 22, and two light sources 23, 24. In FIG. 2, the transparent panel 21, which may be a glass panel, is installed above of the fingerprint scanning device 11, and configured for receiving a fingerprint, mainly by pressing a finger tip on the transparent panel 21. The camera 22 is vertical below the transparent panel 21, and configured for scanning the fingerprint, and obtaining a fingerprint image. The light sources 23, 24 are placed on either side of the transparent panel 21, and configured for illuminating the transparent panel 21, so as to aide the camera 22 to scan the fingerprint and obtain the fingerprint image clearly. When compared with the exemplary embodiment of the fingerprint scanning device 11 as shown in FIG. 2, in another exemplary embodiment of the fingerprint scanning device 11 as shown in FIG. 3, the light sources 23, 24 are placed on either side of the camera 22 and vertical to the transparent panel 21.

The memory 12 may be an internal memory card or an external memory card. The external memory card may include a smart media card (SMC), a secure digital card (SDC), a compact flash card (CFC), a multi media card (MMC), a memory stick (MS), an extreme digital card (XDC), and a trans flash card (TFC). The memory 12 is configured for storing original fingerprint characteristic values of corresponding user accounts. The fingerprint characteristic values are analogous to a username and password or login ID of typical access management systems, and here, original represents an initial setting of one of the user accounts. The original fingerprint characteristic values include a characteristic point count, characteristic point coordinates, a linked shape of the characteristic points, and relative positions between adjacent characteristic points.

The handheld device 1 further includes a fingerprint scanning module 110, a processing module 120, a fingerprint characteristic detecting module 130, a storing module 140, a determining module 150, and a validating module 160.

The fingerprint scanning module 110 is connected to the fingerprint scanning device 11, and configured for controlling the fingerprint scanning device 11 to scan and obtain original fingerprint images of the user accounts correspondingly. In other words, each of the user accounts would be assigned to one of the original fingerprint images accordingly.

The processing module 120 is configured for processing the original fingerprint images, and obtaining corresponding negative images of the original fingerprint images. The processing of the original fingerprint images involves: regulating luminance and contrast of the original fingerprint images; converting the original fingerprint images into black and white images; regulating color gradation of the original fingerprint images; converting the original fingerprint images into negative images having opposite luminance and complemental color with the original fingerprint images.

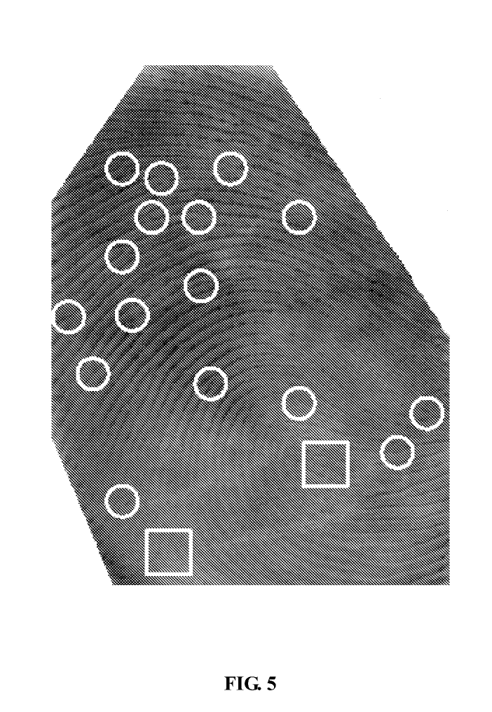

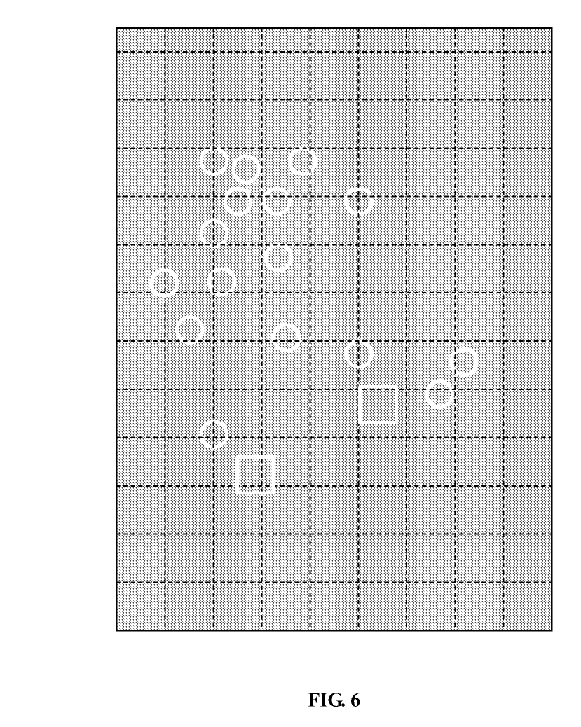

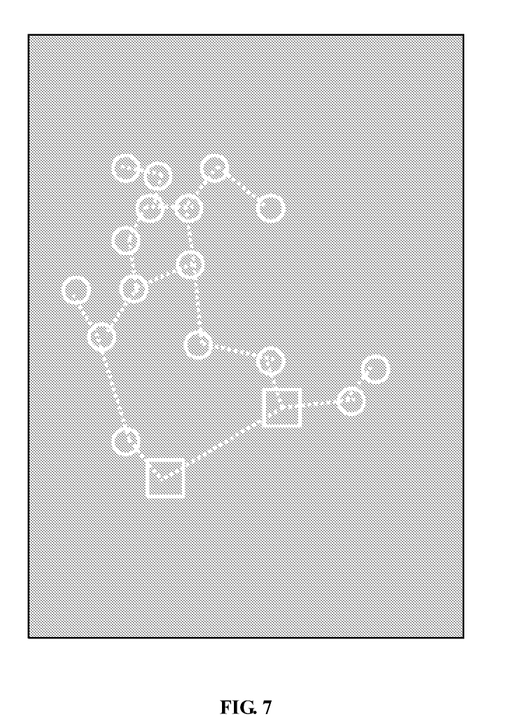

The fingerprint characteristic detecting module 130 is configured for detecting original fingerprint characteristic points in the negative images of the original fingerprint image, and computing original fingerprint characteristic values according to the original fingerprint characteristic points. For example, FIG. 5 shows an example of characteristic points, which may be the original fingerprint characteristic points or login fingerprint characteristic points. As shown in FIG. 5, the negative image of the fingerprint image is highlighted with a plurality of circular parts and rectangular parts. The circular parts and the rectangular parts indicate the characteristic points detected in the negative image. The circular parts represent main characteristic points, which include whorl and triradius; and the rectangular parts represent sub characteristic points, which include broken fingerprint ridges and bifurcating fingerprint ridges. In FIG. 5, a count of the rectangular parts is 2, which indicates that the count of the main characteristic points is 2. The count of the circular parts is 16, which indicates that the count of the sub characteristic points is 16. FIG. 6 shows a graphical representation of establishing a coordinate system on the characteristic points in accordance with the exemplary embodiment. The coordinates of the characteristic points may be computed according to the established coordinate system. FIG. 7 shows a graphical representation of a linked shape of the characteristic points of a fingerprint in accordance with the exemplary embodiment. The process of linking the characteristic points to form the linked shape involves: computing relative positions between adjacent characteristic points and connecting centers of the adjacent characteristic points according to the computed relative positions.

The storing module 140 is connected to the memory 12, and configured for storing the original fingerprint characteristic points and the original fingerprint characteristic values into the memory 12.

The fingerprint scanning module 110 is further configured for controlling the fingerprint scanning device 11 to scan a login fingerprint of a user accessing one of the user accounts of the handheld device 1, and obtaining a login fingerprint image correspondingly.

The processing module 120 is further configured for processing the login fingerprint image, and obtaining a negative image of the login fingerprint image.

The fingerprint characteristic detecting module 130 is further configured for detecting login fingerprint characteristic points in the negative image of the login fingerprint image, and computing login fingerprint characteristic values according to the login fingerprint characteristic points. The login fingerprint characteristic values also include the characteristic point count, the characteristic point coordinates, the linked shape of the characteristic points, and the relative positions between adjacent characteristic points. The process of detecting login fingerprint characteristic points and computing login fingerprint characteristic values is the same as the process of detecting the original fingerprint characteristic points and computing the original fingerprint characteristic values.

The determining module 150 is configured for determining whether the login fingerprint characteristic values match original fingerprint characteristic values of one of the user accounts in the memory 12. For example, if a count of the main characteristic points in the login fingerprint characteristic points is equal to a count of the main characteristic points in the original fingerprint characteristic points, and a count of the sub-characteristic points in the login fingerprint characteristic points is more than 60 percent of a count of the sub-characteristic points in the original fingerprint characteristic points of one of the user accounts, thus the login fingerprint characteristic values is determined to match the original fingerprint characteristic values of the user account.

The validating module 160 is configured for granting access to the user account if the login fingerprint characteristic values match the original fingerprint characteristic values of one of the user accounts in the memory 12, and configured for denying access to the handheld device 1 if the login fingerprint characteristic values do not match the original fingerprint characteristic values of any of the user accounts in the memory 12.

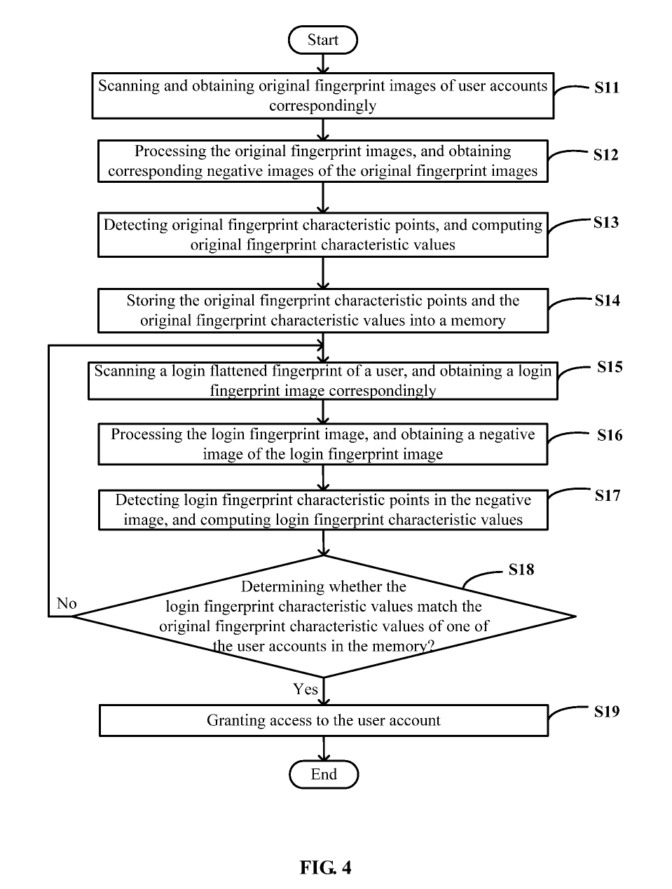

FIG. 4 is a flowchart of a method for controlling access to a handheld device by validating fingerprints in accordance with the exemplary embodiment.

In step S11, the fingerprint scanning module 110 controls the fingerprint scanning device 11 to scan and obtain the original fingerprint images of the user accounts correspondingly.

In step S12, the processing module 120 processes the original fingerprint images, and obtains corresponding negative images of the original fingerprint images. The processing of the original fingerprint images involves: regulating luminance and contrast of the original fingerprint images; converting the original fingerprint images into black and white images; regulating color gradation of the original fingerprint images; converting the original fingerprint images into negative images.

In step S13, the fingerprint characteristic detecting module 130 detects the original fingerprint characteristic points in the negative images of the original fingerprint image, and computes the original fingerprint characteristic values according to the original fingerprint characteristic points.

In step S14, the storing module 140 stores the original fingerprint characteristic points and the original fingerprint characteristic values into the memory 12.

In step S15, the fingerprint scanning module 110 controls the fingerprint scanning device 11 to scan the login fingerprint of a user accessing one of the user accounts of the handheld device 1, and obtains the login fingerprint image correspondingly.

In step S16, the processing module 120 processes the login fingerprint image, and obtains the negative image of the login fingerprint image.

In step S17, the fingerprint characteristic detecting module 130 detects the login fingerprint characteristic points in the negative image of the login fingerprint image, and computes the login fingerprint characteristic values according to the login fingerprint characteristic points.

In step S18, the determining module 150 determines whether the login fingerprint characteristic values match the original fingerprint characteristic values of one of the user accounts in the memory 12.

In step S19, if the login fingerprint characteristic values match the original fingerprint characteristic values of one of the user accounts in the memory 12, the validating module 160 grants access to the user account, and the procedure ends.

If the login fingerprint characteristic values do not match the original fingerprint characteristic values of any of the user accounts in the memory 12 in step S18, the validating module 160 denies access the handheld device 1, and the procedure returns to the step S15.

It should be emphasized that the above-described embodiments of the exemplary embodiments are merely possible examples of implementations, merely set forth for a clear understanding of the principles of the invention. Many variations and modifications may be made to the above-described exemplary embodiment without departing substantially from the spirit and principles of the invention. All such modifications and variations are intended to be included herein within the scope of this disclosure and the above-described exemplary embodiment and protected by the following claims.

What is claimed is:

1. A system for controlling access to a handheld device by validating fingerprints, the handheld device comprising:
a memory for storing original fingerprint characteristic values of corresponding user accounts;
a fingerprint scanning module for controlling a fingerprint scanning device in the handheld device to scan a login fingerprint of a user accessing one of the user accounts, and obtaining a login fingerprint image correspondingly;
a processing module configured for processing the login fingerprint image, and obtaining a negative image of the login fingerprint image;
a fingerprint characteristic detecting module configured for detecting login fingerprint characteristic points in the negative image of the login fingerprint image, and computing login fingerprint characteristic values according to the login fingerprint characteristic points;
a determining module configured for determining whether the login fingerprint characteristic values match original fingerprint characteristic values of one of the user accounts in the memory; and
a validating module configured for granting access to the user account if the login fingerprint characteristic values match the original fingerprint characteristic values of the user account in the memory.

2. The system according to claim 1, wherein:
the handheld device further comprises a storing module;
the fingerprint scanning module is further configured for controlling the fingerprint scanning device to scan and obtain original fingerprint images of corresponding user accounts;
the processing module is further configured for processing the original fingerprint images, and obtaining negative images of the original fingerprint images;
the fingerprint characteristic detecting module is further configured for detecting original fingerprint characteristic points in the negative images of the original fingerprint image, and computing original fingerprint characteristic values according to the original fingerprint characteristic points; and
the storing module is configured for storing the original fingerprint characteristic points and the original fingerprint characteristic values into the memory.

3. The system according to claim 1, wherein:
the fingerprint scanning device comprises a transparent panel, a camera, and two light sources;
the transparent panel is installed above the fingerprint scanning device, and configured for receiving a fingerprint;
the camera is vertical to the transparent panel, and configured for scanning the fingerprint, and obtaining a fingerprint image; and
the two light sources are configured for illuminating the transparent panel.

4. The system according to claim 3, wherein the two lights are placed on either side of the transparent panel.

5. The system according to claim 3, wherein the two lights are placed on either side of the camera and vertical to the transparent panel.

6. The system according to claim 1, wherein the characteristic points comprises main characteristic points and sub characteristic points.

7. The system according to claim 6, wherein the main characteristic points comprises whorl and triradius, and the sub characteristic points comprises broken fingerprint ridges and bifurcating fingerprint ridges.

8. The system according to claim 1, wherein: the processing module is further configured for regulating luminance and contrast of the original fingerprint images; converting the original fingerprint images into black and white images; regulating color gradation of the original fingerprint images; and converting the original fingerprint images into negative images.

9. The system according to claim 1, wherein the original fingerprint characteristic values and the login fingerprint characteristic values comprises a characteristic point count, characteristic point coordinates, a linked shape of the characteristic points, and relative positions between adjacent characteristic points.

10. A method for controlling access to a handheld device by validating fingerprints, the method comprising:
storing original fingerprint characteristic values of corresponding user accounts in a memory of the handheld device;
controlling a fingerprint scanning device in the handheld device to scan a login fingerprint of a user accessing one of the user accounts, and obtaining a login fingerprint image correspondingly;
processing the login fingerprint image, and obtaining a negative image of the login fingerprint image;
detecting login fingerprint characteristic points in the negative image of the login fingerprint image, and computing login fingerprint characteristic values according to the login fingerprint characteristic points;
determining whether the login fingerprint characteristic values match original fingerprint characteristic values of one of the user accounts in the memory; and
granting access to the user account if the login fingerprint characteristic values match the original fingerprint characteristic values of the user account in the memory.

11. The method according to claim 10, wherein the storing step further comprising:
controlling the fingerprint scanning device to scan and obtain original fingerprint images of corresponding user accounts;
processing the original fingerprint images, and obtaining negative images of the original fingerprint images;
detecting original fingerprint characteristic points in the negative images of the original fingerprint image, and computing original fingerprint characteristic values according to the original fingerprint characteristic points; and
storing the original fingerprint characteristic points and the original fingerprint characteristic values into the memory.

12. The method according to claim 10, the original fingerprint characteristic values and the login fingerprint characteristic values comprises a characteristic point count, characteristic point coordinates, a linked shape of the characteristic points, and relative positions between adjacent characteristic points.
